(19) United States
(12) Patent Application Publication
(10) Pub. No.: US 2026/0030647 A1
(43) Pub. Date: Jan. 29, 2026

(54) MACHINE LEARNING APPROACH TO DETERMINISTIC USE OF INTERVENTIONS IN RELATION TO PHYSICAL OBJECT DISCREPANCY

(71) Applicant: Maplebear Inc., San Francisco, CA (US)

(72) Inventors: Ahsaas Bajaj, Jersey City, NJ (US); Shishir Kumar Prasad, Fremont, CA (US); Ying Li, San Francisco, CA (US); Sumiran Pradhan, Bothell, WA (US); Rohit Turumella, Cupertino, CA (US); Divya Kesav Srikantaiah, San Francisco, CA (US); Vagisha Ahlawat, Austin, TX (US)

(21) Appl. No.: 18/780,999

(22) Filed: Jul. 23, 2024

(51) Int. Cl. G06Q 30/0202

(52) U.S. Cl. CPC G06Q 30/0202

(57) ABSTRACT

A system and a method are disclosed for predicting future user engagement with a mobile device application based on a discrepancy detected between two physical objects. In an embodiment, a physical object provider receives, based on user input into the application, a request for delivery of a first physical object. A discrepancy is detected, the discrepancy reflecting that a second physical object is detected in place of the first physical object. A first set of features of the first physical object and a second set of features of the second physical object are inputted into a machine learning model. The machine learning model outputs a measure of predicted future engagement of the user with the application based on the discrepancy. The application is instructed to output an intervention based on the measure of predicted future engagement of the user.

### BACKGROUND

Discrepancies may occur in online delivery systems when physical objects delivered to a user do not exactly match the objects ordered by the user. The discrepancies between ordered and actually delivered physical objects may occur due to limitations of models for determining like-for-like physical objects, for example, large language model (LLM) hallucinations. The discrepancies are inevitable due to these technological limitations. Users are prone to request an intervention (e.g., delivery of the originally requested physical object) which consumes additional network resources and can introduce computationally intense LLM analysis of the intervention request.

### SUMMARY

The online delivery system may proactively determine whether to perform interventions by determining the magnitude of the discrepancies. The discrepancies may vary from minor to large, and the interventions may be automatically applied where discrepancies are sufficiently large, thus saving on massive computational resources (e.g., network bandwidth from user requests; LLM bandwidth for running a chatbot to process user requests, etc.).

In accordance with one or more aspects of the disclosure, an online delivery system receives, based on user input into the mobile device application, a request for delivery of a first physical object. A discrepancy is detected wherein a second physical object is obtained instead of the first physical object. A first set of features of the first physical object and a second set of features of the second physical object are inputted into a machine learning model. The machine learning model outputs a measure of predicted future engagement of the user with the application based on the discrepancy. The application is instructed to output an intervention based on the measure of predicted future engagement of the user.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example system architecture for an intervention module, in accordance with one or more embodiments.

FIG. 4 is a flowchart of a method for predicting future user engagement with a mobile device application based on a discrepancy detected between two physical objects, according to one or more embodiments.

### DETAILED DESCRIPTION

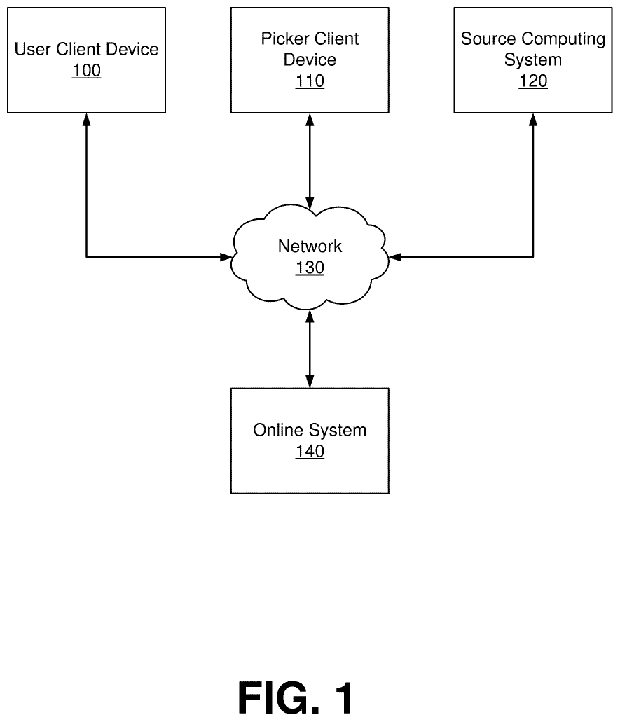

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item”, as used herein, may be an example of a physical object. While the item is used as an example of the physical object in this disclosure, the physical object may also include other examples. The item may refer to a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive recipes or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 can receive the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source when available. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

A substitution can occur when a second item is selected in place of a first item because the first item is unavailable. This unavailability may be due because of various reasons, including the first item being out of stock, discontinued, or temporarily inaccessible. For example, the picker, using the picker client device 110, may attempt to locate the originally ordered item. Responsive to finding that the originally ordered item is unavailable, the picker may select a similar or comparable item as a substitute. The picker may scan or capture an image of the substitute item using the picker client device 110. The online system 140 may detect that the scanned item does not match the originally ordered item, triggering a substitution event.

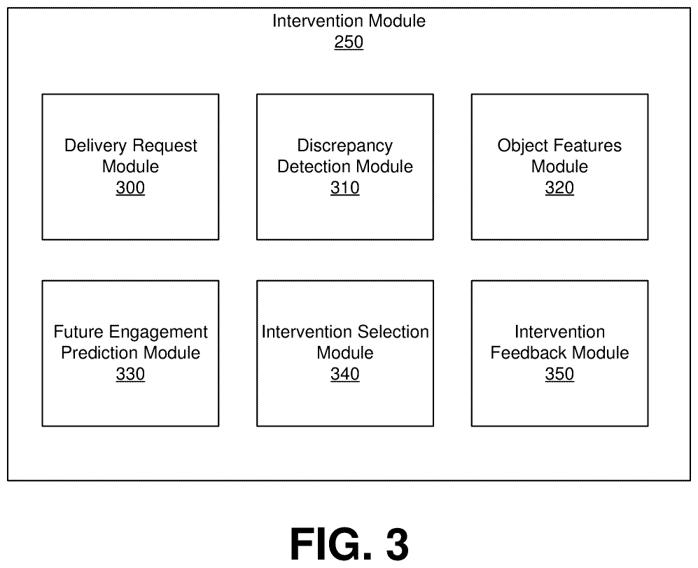

A discrepancy may be an event that occurs when there is a mismatch between an item listed in an order for the picker to select and the item actually collected by the picker to satisfy the order. A discrepancy may be detected by the discrepancy detection module 310, which is discussed in further detail below with regards to FIG. 3. A substitution may result in a discrepancy. But not all discrepancies are results of substitutions. For example, a discrepancy may occur responsive to the picker accidentally selecting the wrong item, an item being damaged, or a system error in item identification.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered.

Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In some embodiments, the online system 140 communicates with a smart physical cart being used by a user to collect items in a source location. For example, the smart physical cart may display content received from the online system and may receive data describing items that are collected by the user and stored in a storage area of the shopping cart. In some embodiments, the smart physical cart is a picker client device 110 being operated by a picker collecting items within a source location. Similarly, the smart physical cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” may be an entity that operates a “source location,” from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140.

lternatively, the source computing system 120 may provide payment to the online system 140 for some portion of the overall cost of a user's order (e.g., as a commission). The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all the of standard layers used to describe a physical or virtual network, such as the physical layer, the data link layer, the network layer, the transport layer, the session layer, the presentation layer, and the application layer.

The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

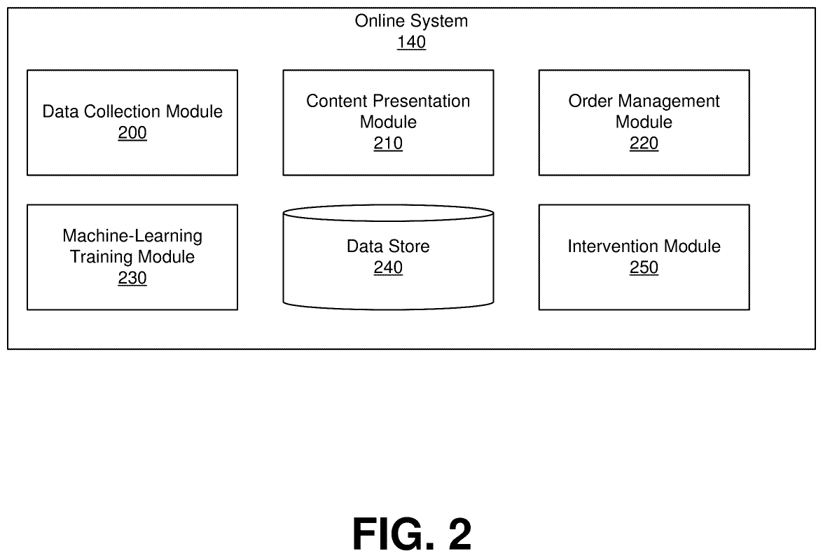

As an example, the online system 140 may allow a user to order physical objects from a source location. The user's order may specify which physical objects they want delivered from the source location and the quantities of each of the physical objects. The user's client device 100 transmits the user's order to the online system 140 and the online system 140 selects a picker to travel to the source location to collect the physical objects ordered by the user. The online system transmits an offer to the picker for the picker to service the order in exchange for consideration and, if the picker accepts the offer, the picker collects the physical objects from the source location. Once the picker has collected the physical objects ordered by the user, the picker delivers the physical objects to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, a data store 240, and an intervention module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In the preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist.

For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm). A discrepancy may occur when there is a mismatch between an item listed in an order for a picker to select and the item actually collected by the picker to satisfy the order. Both items may be in a same item category. The discrepancy detection module 310 detects discrepancies and is described in further detail below with regards to FIG. 3.

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection.

The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 can train machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models.

A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 can train a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 may score the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may train a machine learning model for predicting the likelihood of user disengagement (i.e., stopping use of the application) if they are not appeased after experiencing a discrepancy between the physical objects they ordered and those they received. Inputs of the machine learning model may include the nature of the discrepancy, the features of the physical object ordered and received by the user, the user's order history, the user's past behavior, and/or any relevant user demographics or characteristics. Outputs of the machine learning model may include a measure of predicted future engagement. The measure of predicted future engagement may represent a prediction of user disengagement if no appeasement action is taken. In some embodiments, the object features module 320 may provide inputs to the machine learning model as explained in reference to FIG. 3. The outputs of the machine learning model may be received by the future engagement prediction module 330. These embodiments are discussed in reference to FIG. 3.

In some embodiments, based on the measure of predicted future engagement, the online system 140 can make a data-driven decision about whether to implement an intervention (or appeasement action) and, if so, what type of action would be most cost-effective. This approach enables the system to determine when and how to intervene in cases of discrepancy. The intervention decision balances appeasement against risk of user disengagement.

In some embodiments, the machine-learning training module 230 may train the machine learning model for predicting the likelihood of user disengagement where an intervention is not performed. The model training process may include the preparation of a comprehensive training data set. The training dataset may include historical information on past discrepancies, user characteristics, order histories, and user disengagement or continued engagement outcomes. The training dataset may include scenarios where no intervention occurred, to model the likelihood of disengagement without intervention. The training dataset may be preprocessed by cleaning, normalizing numerical features, encoding categorical variables, and engineering relevant features such as discrepancy severity, user order frequency, and history of experiencing discrepancies. The training dataset may be split into training, validation, and test datasets.

Training of the machine learning model may include selecting an appropriate algorithm (such as logistic regression, random forests, or neural networks) and training it on the prepared training set. Techniques like cross-validation may be employed to provide the model's robustness. The model's hyperparameters may be optimized using methods like grid search or Bayesian optimization. The machine learning model evaluation may be performed using the validation dataset. Performance metrics such as AUC-ROC, precision, recall, and F1-score may be used to assess the model's accuracy in predicting disengagement. Feature importance analysis may be conducted to understand the key factors influencing disengagement predictions. Based on this evaluation, the machine learning model may undergo iterative refinement, which may include adjusting features, trying different machine learning model architectures, or implementing ensemble methods. The machine learning model may be tested on the test dataset to get an estimate of its performance before deployment.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

In some embodiments, the machine-learning training module 230 may re-train the machine learning model based on user feedback data, which may include historical information on past discrepancies, user characteristics, order histories, and user feedback data. The machine-learning training module 230 may include the user feedback data into the training dataset. The training dataset may undergo preprocessing to ensure data quality and consistency. The preprocessing step may include cleaning and preparing the raw training dataset for optimal use by the machine learning model by handling missing values, normalizing numerical features to a common scale, and encoding categorical variables into a format suitable for machine learning algorithms. The preprocessing step may also include feature engineering, where new relevant features are created or existing ones are transformed to better capture the underlying patterns in the data.

The machine-learning training module 230 may split the preprocessed training dataset into a training subset and a validation subset. The training process may include inputting the training subset into the machine learning model, which generates predicted measures of future user engagement. The machine-learning training module 230 may compare these predictions against actual engagement data from the validation subset. A loss function can quantify the discrepancy between predicted and actual engagement to adjust the machine learning model parameters for minimize the loss. This training process can be iteratively refined until the machine learning model meet a predetermined performance threshold. By employing this structured approach to model training, the machine-learning training module 230 can learn from historical data patterns, leading to more accurate predictions of user engagement in response to various discrepancy scenarios and enabling more informed intervention decisions.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data. The intervention module 250 is described in further detail below with regards to FIG. 3.

FIG. 3 illustrates an example system architecture for an intervention module 250, in accordance with some embodiments. The system architecture illustrated in FIG. 3 includes a delivery request module 300, a discrepancy detection module 310, an object feature module 320, a future engagement prediction module 330, an intervention selection module 340, and an intervention feedback module 350. Alternative embodiments may include more, fewer, or different components from those illustrated in FIG. 3, and the functionality of each component may be divided between the components differently from the description below.

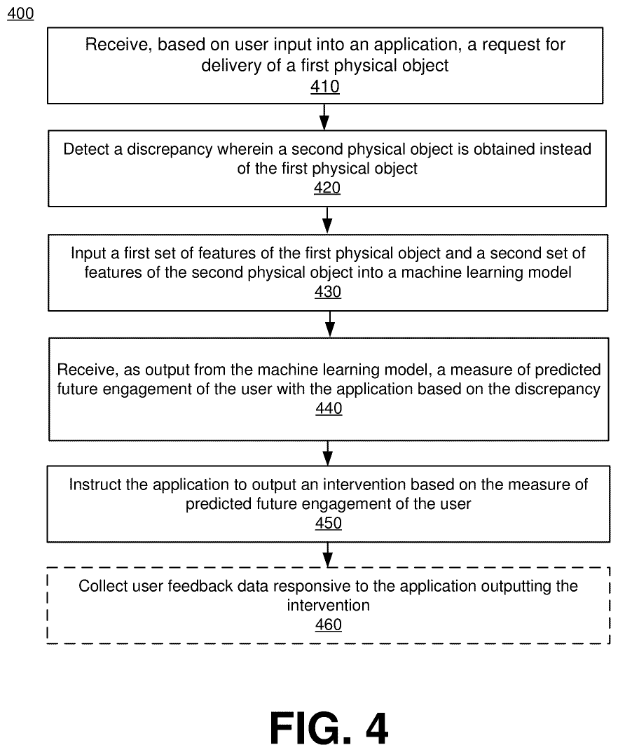

The delivery request module 300 can receive and process user orders for physical objects. The discrepancy detection module 310 can identify a discrepancy between ordered and delivered physical objects. Responsive to detecting a mismatch, the object feature module 320 can input features of the ordered and delivered objects into a machine learning model. The future engagement prediction module 330 can receive the machine learning model's output, which can include a measure of predicted future engagement of the user with the application based on the discrepancy. The intervention selection module 340 can determine and initiate appropriate interventions based on the measure of predicted future user engagement. The intervention feedback module 350 can capture user feedback data following the application outputting an intervention, collecting information on user engagement with the application. These modules will be discussed in further details with respect to FIG. 4.

FIG. 4 is a flowchart depicting an example process 400 for predicting future user engagement with a mobile device application based on a discrepancy detected between two physical objects, in accordance with some embodiments. Some steps of the process 400 may be performed by one or more modules of the intervention module 250 illustrated in FIG. 3. The process 400 may be embodied as a software algorithm that may be stored as computer instructions that are executable by one or more processors. The instructions, when executed by the processors, cause the processors to perform various steps in the process 400. In various embodiments, the process 400 may include additional, fewer, or different steps. In some embodiments, the delivery request module 300 can receive, based on user input into an application, a request for delivery of a first physical object (step 410).

The delivery request module 300 can manage the reception of a user's request for the delivery of a physical object. With reference to FIGS. 1 and 2, a user may use the ordering interface of the user client device 100 to place an order for physical objects with the online system 140. A physical object may be a specified item that a user requests for delivery through the online system 140. The physical object may be a food item, a book, an electronic device, or any other type of physical object available for order. Each physical object may have specific features, dimensions, and other unique characteristics For example, the delivery request module 300 receives the delivery request from the online system 140.

Continuing with reference to FIG. 4, in some embodiments, the discrepancy detection module 310 can detect a discrepancy wherein a second physical object is obtained instead of the first physical object (step 420). A discrepancy is an event that occurs when there is a mismatch between the physical object that the user requests for delivery and the physical object that is selected for delivery by the picker and/or delivered to the user. For example, a user may request delivery of a physical object of a category where several brands provide versions of the physical object, and a given brand was selected as part of the request, through the online system 140. After the order is processed, the picker may mistakenly select a different brand of the physical object within the same category for delivery. In this case, the physical object selected for delivery to the user does not match the one selected by the user. The mismatch is what constitutes a discrepancy.

A discrepancy reflects that a second physical object is detected in place of the first physical object. In one approach, the discrepancy detection module 310 receives information from a scanning system identifying an identifier on the second physical object. Using the scanned identifier, the discrepancy detection module 310 may retrieve the information describing the second physical object in a database indexed by the scanned identifier, such as the data store 240.

Examples of the scanning system include the picker client device 110, a point-of-sale (POS) system or any other electronic system that can identify physical objects based on their distinctive features. The distinctive features may be, for example, barcodes, quick response (QR) codes, radio frequency identification (RFID) tags, etc. For example, the picker may select the second physical object as fulfilling a user request for a first physical object. By using the picker client device 110, the picker may scan the second physical object and/or identify it as collected.

Responsive to the scanning system identifying the second physical object, the information is transmitted to the discrepancy detection module 310. This information may contain details about the second physical object, such as product name, brand, specifications, unique identifiers, etc. Some of the function of this module is to verify whether the second physical object (i.e., the physical object selected for delivery) matches the first physical object (i.e., the physical object initially ordered by the user).

Based on the received information, the discrepancy detection module 310 may detect that the second physical object is not a same physical object as the first physical object. For example, the discrepancy detection module 310 compares the information from the scanning system about the second physical object against the corresponding information of the first physical object. The discrepancy detection module 310 may cross-check the attributes (or features) of the second physical object against the first physical object. Responsive to discrepancy detection module 310 determining that the attributes of the second physical object do not match those of the first physical object, a discrepancy detection module 310 may determine that a discrepancy is detected.

For example, when the picker selects a physical object for delivery (the second physical object), the picker client device 110 may scan an identifier on the second physical object. Using the scanned identifier, the picker client device 110 may retrieve information describing the second physical object in the data store 240 indexed by the scanned identifier. The retrieved information may include any combination of a brand, weight, and any other distinguishing attributes of the second physical object. These attributes are encoded as the features of the second physical object. The picker client device 110 sends this information to the discrepancy detection module 310. Information on the specific brand of the first physical object may be stored on the data store 240. The discrepancy detection module 310 may retrieve the attributes of the specific brand of the first physical object ordered by the user from the data store 240 and compare them with the attributes of the second physical object selected by the picker.

The object features module 320 inputs a first set of features of the first physical object and a second set of features of the second physical object into a machine learning model. In some embodiments, in addition to the features of the first and second physical objects, the object features module 320 may input other relevant user data into the machine learning model, including the user's order history, previous experiences with discrepancies, response to past interventions, overall ordering patterns, and engagement metrics with the application. These features may provide a basis on which the machine learning model predicts future user engagement. The item data, collected by the data collection module 200 of FIG. 2, may be examples of the features of the first and second physical objects. While the item data are used as examples of the features of the first and second physical objects in this disclosure, the features of the first and second physical objects may also include other examples.

The machine learning model may be one of the models trained by the machine-learning training module 230 of FIG. 2. For example, the machine learning model may be a model for predicting the likelihood of user disengagement with or without intervention, trained by the machine-learning training module 230. A discussion of the machine learning model is provided with reference to the machine-learning training module 230 of FIG. 2.

Continuing with reference to FIG. 4, in some embodiments, responsive to detecting the discrepancy, the object features module 320 can input a first set of features of the first physical object and a second set of features of the second physical object into a machine learning model (step 430). The object features module 320 may also provide the inputs to the machine learning model responsive to receiving further user input from the user regarding the second physical object. The user input may include more precise details or specific characteristics of the first or second physical object. These details may provide further discrepancies between the first physical object (what is ordered) and the second physical object (what is delivered or selected for delivery). In some embodiments, the user inputs may include inputs from a user ordering a first physical object with the online system 140 through the ordering interface of the user client devices 100 as provided with reference to FIGS. 1-2. The user inputs may be included in the ordering list. The user inputs may be saved by the online system 140 on the data store 240. The object features module 320 may retrieve the user inputs from the data store 240.

In some embodiments, the user inputs may further include inputs from a picker that is servicing an order. The picker may use the picker client device 110 to communicate with the online system 140 to provide inputs regarding the second physical object. These inputs may be saved by the online system 140 on the data store 240. The object features module 320 may retrieve these inputs from the data store 240. These inputs may include features of the physical object including, for example, size, color, and other specifications. Responsive to retrieving the user inputs from the data store 240, the object features module 320 may process these features to transform them into a format suitable for the machine learning model, such as through processes of feature encoding and normalization. The object features module 320 may input the features of the first and second physical objects into the machine learning model. The object features module 320 may further input the user's order history and past behavior into the machine learning model. These inputs may allow the machine learning model to better understand a discrepancy between the first and second physical objects and refine its prediction regarding future user engagement with the application.

The object features module 320 may process to input the features of the first and second physical objects into the machine learning model. Initially, it gathers the relevant features of both objects. For example, the object features module 320 may convert these features into latent space embeddings.

In some embodiments, the act, by the object features module 320, of inputting the features of the first and second physical objects into the machine learning model may further include converting these features into latent space embeddings, generating a similarity metric based on the embeddings, and inputting the similarity metric into the machine learning model. An embedding may be an embedding vector located in a latent space of the machine learning model. The latent space may be one of the spaces in a hidden layer of the first machine learning model. For example, the machine learning model may transform feature representations into a form that can be plotted in an N-dimensional space, known as the latent space. The transformed representation is known as the embedding.

The latent space may refer to an N-dimensional space (e.g., N>10, 100, 1000, or any other number) which may be part of a hidden layer of the machine learning model to represent the input data. The dimensions of the latent space may be called latent variables or latent dimensions. These latent variables may encode different properties of the features data. The machine learning model may process and understand the similarities and differences between various features data. For example, physical objects with similar characteristics may be positioned closer to each other, allowing for easy identification of similar objects for comparison purposes, and conversely, those that are dissimilar may be farther apart. The embeddings of the first physical object may have a first position within the latent space. The embeddings of the second physical object may have a second position within the latent space. The first and second positions may not be arbitrary and may be determined by the features of the first and second physical objects.

The first and second positions may be close to each other. Alternatively, the first and second positions may be far apart. In some embodiments, the latent space may be a multi-dimensional space where each dimension corresponds to a latent variable. The machine learning model may transform the representations into the embeddings, indexing each of them in this multi-dimensional space. The positioning of the embeddings within the latent space may be based on the training of the machine learning model. The machine learning model may generate a similarity metric based on the embeddings. The similarity metric may provide a quantitative measure of the discrepancy between the first and second physical objects. The similarity metric may be determined by examining the relative locations of the embeddings of the first and second physical objects in the latent space. For example, the machine learning model may calculate the similarity metric as a numerical distance between the embeddings of the first and second physical objects. If these two objects have similar characteristics, their embeddings in the latent space may be closer to each other. This may indicate a high similarity metric. Conversely, if they are dissimilar, their embeddings may be farther apart, suggesting a low similarity metric. The similarity metric may influence the machine learning model's ability to perceive the degree of discrepancy between the first and second physical objects. The similarity metric may provide the machine learning model to refine its predictions concerning the user's potential future engagement with the application.

Continuing with reference to FIG. 4, in some embodiments, the future engagement prediction module 330 can receive, as output from the machine learning model, a measure of predicted future engagement of the user with the application based on the discrepancy (step 440). The future engagement prediction module 330 may store the outputs of the machine learning model in the data store 240 in reference to FIG. 2. The measure of predicted future engagement may be an indicator of how likely the user is to continue interacting with the application given the discrepancy. In other words, the nature of the discrepancy may significantly impact the user's future usage of the application.

In some embodiments, the measure of predicted future engagement may be represented by a categorical classification with, optionally, a level of confidence. The categorical classification may include distinct categories such as “high,” “medium,” and “low,” each representing a different level of predicted future engagement. For example, “high” engagement may indicate a strong likelihood that the user will continue to interact frequently with the application, possibly even increasing their usage. “Medium” engagement may indicate that the user is likely to continue using the application, but their engagement level may remain static or slightly decrease. For example, “low” engagement may indicate a risk of reduced interaction or potential disengagement, where the user may decrease their use of, or stop using, the application. The measure of predicted future engagement may further include a level of confidence with the categorical classification. The confidence level may be represented as a percentage, indicating the machine learning model's certainty in its prediction. For example, the measure of predicted future engagement may be “medium engagement with 80% confidence.” The high/medium/low categorization is merely exemplary. Any number and representation of categorizations may be used.

The machine learning model may output these classifications based on various factors, including the nature and severity of the detected discrepancy. Responsive to a first type of discrepancy (e.g., a small difference in the weight of the physical object), the measure of predicted future engagement may be “high” with a confidence level over 80%, which indicates that users are likely to overlook or quickly forget such small discrepancies. Responsive to a second type of discrepancy (e.g., delivery of a similar but not identical physical object), the measure of predicted future engagement may be “medium” engagement, which indicates the uncertainty about how the user may react. In cases of a third type of discrepancies (e.g., delivery of the wrong physical object), the measure of predicted future engagement may be “low” with 90% confidence, indicating a substantial risk of user dissatisfaction and disengagement. In some embodiments, the measure of predicted future engagement may be represented by a score. The score may be a numerical value ranging from 0 to 1. Alternatively, the score may be a probability value ranging from 0% to 100%. Score values higher than 0.8 (80%) may indicate a greater likelihood of continued user engagement with the application.

For example, a score of 0.9 (or 90%) may indicate a very high probability of continued engagement, suggesting that the user is likely to maintain or even increase their interaction with the application despite any minor discrepancies. A score of 0.5 (or 50%) may indicate uncertainty such as an equal chance of continued user engagement or disengagement. This score may provide a need for an intervention, such as a courtesy message to the user. A score of 0.1 (or 10%) may indicate a very low probability of continued engagement, such as a risk of user disengagement and a likely need for an immediate and significant intervention. The score may be a floating point number between 0 and 1 that is directly proportional to the likelihood of future engagement.

The machine learning model may provide these scores based on various factors, including the nature and severity of the detected discrepancy, the user's history with the application, and patterns observed from similar users. For example, minor discrepancies, such as small differences in the physical object specifications, may result in high scores (e.g., 0.8 to 0.95), indicating that users are likely to overlook or quickly forget these discrepancies.

Moderate discrepancies, such as the delivery of a similar but not identical physical object, may result in mid-range scores (e.g., 0.4 to 0.7), indicating increased uncertainty about the user's future engagement. Major discrepancies, such as delivery of an entirely wrong physical object, may result in low probability scores (e.g., 0.1 to 0.3), indicating a risk of user dissatisfaction and potential disengagement. The intervention selection module 340 may receive the measure of predicted future engagement from the future engagement prediction module 330.

Continuing with reference to FIG. 4, in some embodiments, the intervention selection module 340 can instruct the application to output an intervention based on the measure of predicted future engagement of the user (step 450). The intervention selection module 340 may maintain a list of potential interventions and select the optimal intervention depending on the categorical classification or the score. An intervention may be an action taken by the application.

In some embodiments, the intervention selection module 340 can use thresholds to identify when and how to provide an intervention. Responsive to the measure of predicted future engagement falling below a certain threshold, the intervention selection module 340 may instruct the application to output an intervention. The intervention may include displaying an indication of a remedial action on the user interface of the client device. Responsive to the measure of predicted future engagement remaining above the threshold, the intervention selection module 340 may instruct the application to not output an intervention. This threshold-based approach may provide the system to balance the need for intervention with the risk of unnecessary actions, optimizing user experience and resource utilization.

In some embodiments, the rules for determining when an intervention is needed may be based on specific thresholds. Responsive to the score falling between a first threshold and 1.0, the intervention selection module 340 may provide no intervention. Responsive to the score falling between a second threshold and the first threshold, the intervention selection module 340 may provide a first type of intervention. Responsive to the score falling between a third threshold and the second threshold, the intervention selection module 340 may provide a second type of intervention. Responsive to the score falling below the third threshold, the intervention selection module 340 may provide a third type of intervention. The first threshold is a high threshold representing confidence that an intervention should not be applied because it is unlikely to favorably influence engagement.

An example of the first threshold is 0.8. The space between the second and third threshold represents a space where an intervention may possibly influence engagement or disengagement, and therefore represents a space where an intervention of lower magnitude is to be applied. The space below the third threshold represents a space where confidence is high that an intervention will result in future engagement and no intervention will result in future disengagement. An example of the second threshold is 0.6. An example of the third threshold is 0.5. An example of the first type of intervention includes the act of the online system 140 sending an electronic message regarding the discrepancy to a user on the user client device 100.

An example of the second type of intervention includes the act of the online system 140 sending an electronic message to user on the user client device 100 to offer a reduction on a value relative to the physical object. An example of the third type of intervention include the act of the online system 140 sending an electronic message to user on the user client device 100 to offer redelivery of the physical object or a value corresponding to the physical object.

Some of the objectives of an intervention include mitigating the impacts of discrepancies on user experience; preventing user disengagement by addressing issues proactively; and maintaining or improving user satisfaction and engagement with the application.

In some embodiments, the intervention selection module 340 may automatically trigger a redelivery process as part of the intervention. This automated redelivery process may include the intervention selection module 340 placing a new request for re-delivery of the first physical object. The order management module 220 may receive and process the re-delivery request by assigning it to an available picker for collection and delivery. Responsive to the re-delivery request, the intervention selection module 340 may send an electronic message to the user's client device 100. The electronic message may include an indication that a re-delivery of the first physical object has been initiated due to the discrepancy. The electronic message may also include an estimated time of arrival for the first physical object. Advantageously, this feature may provide remedial action to correct the discrepancy without requiring any additional input from the user to mitigate their dissatisfaction and increasing the likelihood of continued engagement with the application.

Continuing with reference to FIG. 4, in some embodiments, the intervention feedback module 350 can optionally collect user feedback data responsive to the application outputting the intervention (step 460). The user feedback data may include user ratings, comments, or subsequent actions taken by the user within the application. The user feedback data may include user ratings, comments, and subsequent user interactions within the application responsive to an intervention, such as future application usage, order placements, and changes in order value or frequency. For example, each instance of feedback data may include an association between an intervention type and the resulting user action.

In some embodiments, the intervention feedback module 350 can capture and process the feedback data to measure the effectiveness of different intervention strategies across various scenarios. The intervention feedback module 350 may use data analytics techniques to identify patterns and trends in user responses to specific intervention types. The intervention feedback module 350 may associate each feedback instance with the corresponding intervention type and the measure of predicted future engagement that triggered it, allowing the system to evaluate the accuracy of its predictions and the effectiveness of the chosen interventions.

The intervention feedback module 350 may provide the collected and processed user feedback data to the machine-learning training module 230 for retraining the machine learning model. This process can provide a feedback loop that enables continuous improvement of the system's intervention selections and overall performance. By incorporating real-world user responses, the intervention module 250 can iteratively refine its predictive capabilities and decision-making processes. Over time, this adaptive approach may lead to increasingly accurate predictions of user engagement across various discrepancy scenarios.

In some embodiments, the intervention feedback module 350 may store the collected user feedback data in a database, such as the data store 240. The machine learning training module 230 may provide a retraining process that include the newly collected feedback data into the existing training dataset. By integrating this up-to-date user response data, the machine learning model can refine its predictions and intervention recommendations over time. This iterative process of collecting feedback, storing it, and using it to retrain the machine learning model may provide a dynamic, self-improving system that becomes overtime increasingly accurate and effective in predicting user engagement and selecting appropriate interventions in response to discrepancies between ordered and delivered physical objects.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A computer-implemented method, comprising:
receiving, based on user input into an application, a request for delivery of a first physical object;
detecting a discrepancy wherein a second physical object is obtained instead of the first physical object;
inputting a first set of features of the first physical object and a second set of features of the second physical object into a machine learning model;
receiving, as output from the machine learning model, a measure of predicted future engagement of the user with the application based on the discrepancy; and
instructing the application to output an intervention based on the measure of predicted future engagement of the user.

2. The method of claim 1, wherein detecting the discrepancy comprises:
receiving information from a scanning system identifying the second physical object as satisfying the request for the first physical object; and
detecting that the second physical object is not a same physical object as the first physical object.

3. The method of claim 1, wherein inputting the features of the first physical object and the features of the second physical object into the machine learning model occurs responsive to detecting the discrepancy.

4. The method of claim 1, wherein inputting the features of the first physical object and the features of the second physical object into the machine learning model occurs responsive to receiving further user input from the user regarding the second physical object.

5. The method of claim 1, wherein inputting the features of the first physical object and the features of the second physical object into the machine learning model further comprises:
converting the features of the first physical object and the features of the second physical object into latent space embeddings;
generating a similarity metric based on the latent space embeddings; and
inputting the similarity metric into the machine learning model.

6. The method of claim 1, wherein instructing the application to output the intervention occurs responsive to identifying that the measure of predicted future engagement of the user falls below a threshold.

7. The method of claim 6, wherein the intervention comprises the application outputting, on a user interface of a client device, an indication of a remedial action.

8. The method of claim 1, wherein the application is configured to not output the intervention responsive to identifying that the measure of predicted future engagement of the user falls above a threshold.

9. The method of claim 1, further comprising training the machine learning model by:
accessing a training dataset comprising historical information on past discrepancies, user characteristics, order histories, and user feedback data;
preprocessing the training dataset;
splitting the preprocessed training dataset into a training subset and a validation subset;
training the machine learning model based on the training subset by:
inputting the training subset into the machine learning model;
receiving, from the machine learning model, predicted measures of future engagement of users with the application based on the inputting;
comparing the predicted measures of future user engagement with actual engagement data in the validation subset;
calculating a loss function based on the comparison;
adjusting parameters of the machine learning model to minimize the loss function; and
iterating the training process until a predetermined performance threshold is met.

10. The method of claim 1, further comprising:
collecting user feedback data responsive to the application outputting the intervention, wherein the user feedback data comprises at least one of:
user actions taken within the application following the intervention, and
user engagement metrics with the application after the intervention;
storing the collected user feedback data in a database;
re-training the machine learning model based, at least in part, on the collected user feedback data, wherein retraining comprises at least:
incorporating the collected user feedback data into the training dataset.

11. A non-transitory computer-readable medium comprising memory with instructions encoded thereon, the instructions causing one or more processors to perform operations when executed, the instructions comprising instructions to:
receive, based on user input into an application, a request for delivery of a first physical object;
detect a discrepancy wherein a second physical object is obtained instead of the first physical object;
input a first set of features of the first physical object and a second set of features of the second physical object into a machine learning model;
receive, as output from the machine learning model, a measure of predicted future engagement of the user with the application based on the discrepancy; and
instruct the application to output an intervention based on the measure of predicted future engagement of the user.

12. The non-transitory computer-readable medium of claim 11, wherein detecting the discrepancy comprises:
receiving information from a scanning system identifying the second physical object as satisfying the request for the first physical object; and
detecting that the second physical object is not a same physical object as the first physical object.

13. The non-transitory computer-readable medium of claim 11, wherein inputting the features of the first physical object and the features of the second physical object into the machine learning model occurs responsive to detecting the discrepancy.

14. The non-transitory computer-readable medium of claim 11, wherein inputting the features of the first physical object and the features of the second physical object into the machine learning model occurs responsive to receiving further user input from the user regarding the second physical object.

15. The non-transitory computer-readable medium of claim 11, wherein the instructions to input the features of the first physical object and the features of the second physical object into the machine learning model further comprise instructions to:
convert the features of the first physical object and the features of the second physical object into latent space embeddings;
generate a similarity metric based on the latent space embeddings; and
input the similarity metric into the machine learning model.

16. The non-transitory computer-readable medium of claim 11, wherein instructing the application to output the intervention occurs responsive to identifying that the measure of predicted future engagement of the user falls below a threshold.

17. The non-transitory computer-readable medium of claim 16, wherein the intervention comprises the application outputting, on a user interface of a client device, an indication of a remedial action.

18. The non-transitory computer-readable medium of claim 11, wherein the application is configured to not output the intervention responsive to identifying that the measure of predicted future engagement of the user falls above a threshold.

19. The non-transitory computer-readable medium of claim 11, further comprising training the machine learning model by:
accessing a training dataset comprising historical information on past discrepancies, user characteristics, order histories, and user feedback data;
preprocessing the training dataset;
splitting the preprocessed training dataset into a training subset and a validation subset;
training the machine learning model based on the training subset by:
inputting the training subset into the machine learning model;
receiving, from the machine learning model, predicted measures of future engagement of users with the application based on the inputting;
comparing the predicted measures of future user engagement with actual engagement data in the validation subset;
calculating a loss function based on the comparison;
adjusting parameters of the machine learning model to minimize the loss function; and
iterating the training process until a predetermined performance threshold is met.

20. A computer system comprising:
one or more processors; and
a non-transitory computer readable storage medium storing instructions that, when executed by the one or more processors, cause the one or more processors to perform operations comprising:
receiving, based on user input into an application, a request for delivery of a first physical object;
detecting a discrepancy wherein a second physical object is obtained instead of the first physical object;
inputting a first set of features of the first physical object and a second set of features of the second physical object into a machine learning model;
receiving, as output from the machine learning model, a measure of predicted future engagement of the user with the application based on the discrepancy; and
instructing the application to output an intervention based on the measure of predicted future engagement of the user.
